(19) United States
(12) Patent Application Publication
(10) Pub. No.: US 2015/0160351 A1
(43) Pub. Date: Jun. 11, 2015

(54) Radiation Detector including an External-Modulated Electro-optical Coupling Detector Architecture for Nuclear Physics Instrumentation

(71) Applicant: JEFFERSON SCIENCE ASSOCIATES, LLC, Newport News, VA (US)

(72) Inventor: Wenze Xi, Odenton, MD (US)

(73) Assignee: JEFFERSON SCIENCE ASSOCIATES, LLC, Newport News, VA (US)

(21) Appl. No.: 14/101,596

(22) Filed: Dec. 10, 2013

(51) Int. Cl. G01T 1/16

(52) U.S. Cl. CPC G01T 1/16

(57) ABSTRACT

A compact radiation tolerant and magnetic field immune radiation detector including a detector front-end having an electro-optical coupling detector (EOCD) capable of operating within high radiation and strong magnetic fields and a back-end that can be located a substantial distance from the front-end and thus away from the high radiation and strong magnetic fields The back-end of the detector includes a multi-wavelength light source and at least one optical receiver. The EOCD in the front-end simultaneously modulates and multiplexes pulses from light sensors by transferring them to the optical domain and then transmitting them through a single-mode fiber to an optical receiver in the back-end. During the fiber transmission, relative phase, amplitude and timing information among multiplexed signals is maintained. High-index silica planar AWGs and electro-optical conversion modulators minimize the effects of radiation damage and ASICs contribute to the compactness of the front-end.

The United States Government may have certain rights to this invention under Management and Operating Contract No. DE-AC05-06OR23177 from the Department of Energy.

### FIELD OF THE INVENTION

The present invention generally relates to generally to radiation detectors, and specifically to a compact radiation tolerant and magnetic field immune radiation detector using an electro-optical coupling detector.

### BACKGROUND OF THE INVENTION

In modern experimental nuclear physics, radiation detectors are the core components to detect, track, and identify particles produced by nuclear decay, cosmic radiation, or in the accelerator reactions. Most detectors work on the fundamentals of material radiation ionization and/or excitation, such as gaseous ionization detectors, semiconductor detectors, and scintillation detectors. Other detectors work on different principles, such as Cerenkov light and transition radiation. Regardless of the purpose, these detectors are placed together or individually for their designated purposes of particle tracking and identification, as well as to determine many attributes of the measured physics quantities, such as momentum, spin, charge, etc. Unfortunately, conventional radiation detectors are of large size, require a lot of floor space, and are not capable of operating in a harsh environment with high radiation, strong magnetic fields, and/or high electromagnetic interference while maintaining high performances for high-count rate handling, low noise, high-energy resolutions, and high timing resolutions.

Conventional radiation detectors typically include a photon sensor, front-end electronics, and a copper wire transmission line to an analog digital converter (ADC). There are several disadvantages with conventional radiation detectors, including a significant space requirement for the photon sensors and the front-end electronics, and a reliance on electrical wires for data transmission. There is a physical limit on the amount of data that can be transferred by electrical wires, thus limiting the high-speed data transmission required by modern radiation detectors. Data transmission via electrical wires leads to low signal fidelity, low readout density, and complex front-end geometry with high mass and a high space requirement.

Conventional radiation detectors include a front-end portion that converts photons into electrical signals. The front-ends must operate in a harsh environment, which typically includes high radiation, strong magnetic fields, and and/or high electromagnetic interference. The front-ends of current state of the art radiation detectors are very susceptible to the high radiation and strong magnetic fields, which lead to a high amount of noise, low energy resolution, low timing resolution, and inability to maintain high-count rate performance. Operation in a high radiation environment and/or strong magnetic fields precludes the use of traditional photomultiplier tubes (PMTs) as they suffer large gain losses even in a residual magnetic field.

What is needed is a radiation detector that is radiation tolerant, immune to magnetic fields, and includes a front-end that is compact in size. The radiation detector should be capable of transmitting large quantities of data at high-speed transmission rates. The radiation detector furthermore should exhibit high signal fidelity, high readout density, and simplified detector front-end complexity with low mass and compactness.

### BRIEF SUMMARY OF THE INVENTION

The current invention is a radiation tolerant and magnetic field immune radiation detector for nuclear physics instrumentation. The radiation detector includes a front-end portion and a back-end portion. The detector front-end can operate successfully inside high radiation and strong magnetic fields and the back-end includes a multi-wavelength light source and at least one optical receiver that can operate in an environment with low background radiation and magnetic fields. The detector back-end can be located at some distance from the front-end. The front-end includes an electro-optical coupling detector (EOCD) that simultaneously modulates and multiplexes pulses from light sensors by transferring them to the optical domain and then transmits them through a single-mode fiber to an optical receiver in the back-end portion. During the fiber transmission, relative phase, amplitude and timing information among multiplexed signals is maintained. A pair of single-mode fibers includes an incoming fiber carrying multi-wavelength light from the multi-wavelength light source to the detector front-end and an outgoing fiber carrying optical signals to the optical receiver. The radiation detector is advantageous over the conventional detector architecture in its high signal fidelity, high readout density, and simplified detector front-end complexity with low mass and compactness. The detector utilizes high-index silica planar arrayed waveguide gratings (AWG) and electro-optical conversion modulators to minimize the effects of radiation damage. The light source module includes a light source including a plurality of standard grid lasers operating at different wavelengths. Optical modulators were installed to modulate electrical signals into the optical domain via the lasers operating wavelength and then multiplexed into a single-mode fiber for optical transmission from the detector front-end to the back-end. In the optical receiver, wavelengths are demultiplexed through an AWG and then electrically converted by optical-photon detectors before digitization. Electrical pulses detected after the electro-optical coupling preserved the original signal characteristics. The EOCD arrangement of the present invention enables a compact, low mass, radiation tolerant and magnetic field immune detector for nuclear physics instrumentation. It also has the potential to greatly reduce the size and complexity of instruments associated with applications of nuclear physics techniques. In order to improve compactness, the front-end portion of the detector includes electronics constructed of Application-Specific Integrated Circuits (ASIC).

### OBJECTS AND ADVANTAGES

One object of the current invention is to provide a radiation detector that includes a front-end that is radiation tolerant and immune to magnetic fields.

As a further object, the radiation detector should be capable of transmitting large quantities of data at high-speed transmission rates to a back-end that can be located at a substantial distance from the radiation tolerant front-end.

The radiation detector furthermore should exhibit high signal fidelity, high readout density, and simplified detector front-end complexity with low mass and compactness.

A further object is to significantly improve the readout density of a radiation detector by use of electro-optical coupling. By using optical fibers or waveguides, the resistive loss that characterizes electrical wires is eliminated.

A further object of the radiation detector is the utilization of wavelength-division-multiplexing (WDM) to further boost the information capacity of optical channels within the detector. An optical fiber is capable of carrying much higher densities of information than electrical wires.

A further advantage of optical transmission of data includes improved signal integrity and timing for either analogue or digital detector front-ends. Low dispersion in optical fibers permits the propagation of optical pulses over distances, as far as 5 KM, with almost no distortion, and thereby ensures the precise timing for analogue radiation pulse signals and high optical signal to noise ratio (OSNR) for digitized signal pulses.

A further object is to provide a radiation detector that utilizes electro-optical coupling in place of the electronics and copper wire transmission of signals of conventional radiation detectors. Electronics and copper wire transmission are replaced by an external modulated photo-electrical charge signal launched into the optical domain with lasers deployed external to the nuclear instrument, thereby providing a compact detector front-end capable of operating in high radiation and strong magnetic fields.

A further object of the radiation detector is to enable simultaneous detector channel transmission over many optical wavelengths through a single-mode fiber.

A further objective is to increase the compactness of the front-end electronics of a radiation detector by use of Application-Specific Integrated Circuits (ASIC). The ASICs are resistant to both high radiation and strong magnetic fields such that detector front-end could operate in a harsh environment.

### BRIEF DESCRIPTION OF THE DRAWINGS

Reference is made herein to the accompanying drawings, which are not necessarily drawn to scale, and wherein:

FIG. 1 is a block diagram of a preferred embodiment of an electro-optical coupling detector according to the present invention.

FIG. 2 is a block diagram of an experimental setup of a two-wavelength electro-optical coupling detector according to the present invention.

FIG. 3 depicts graphical results of an electrical pulse generated from a waveform generator of FIG. 2.

FIG. 4 a plot of EOCD FWHM 1% zoom-in comparison among five experiments with the two-wavelength EOCD system of FIG. 2.

FIG. 5 is a plot of EOCD rising edge 10% zoom-in comparison among five experiments.

FIG. 6 is a plot of EOCD falling edge 10% zoom-in comparison among five experiments.

FIG. 7 is a plot of EOCD amplitude 10% zoom-in comparison among four experiments.

FIG. 8 is a plot of the simultaneous transmission of two pulse-modulated wavelengths.

FIG. 9 depicts the AWG Channel 7 output spectrum analysis with both lasers on.

FIG. 10 depicts the AWG Channel 8 output spectrum analysis with both lasers on.

FIG. 11 depicts the AWG Channel 6 output spectrum analysis with both lasers on.

FIG. 12 depicts the AWG Channel 9 output spectrum analysis with both lasers on.

### DETAILED DESCRIPTION

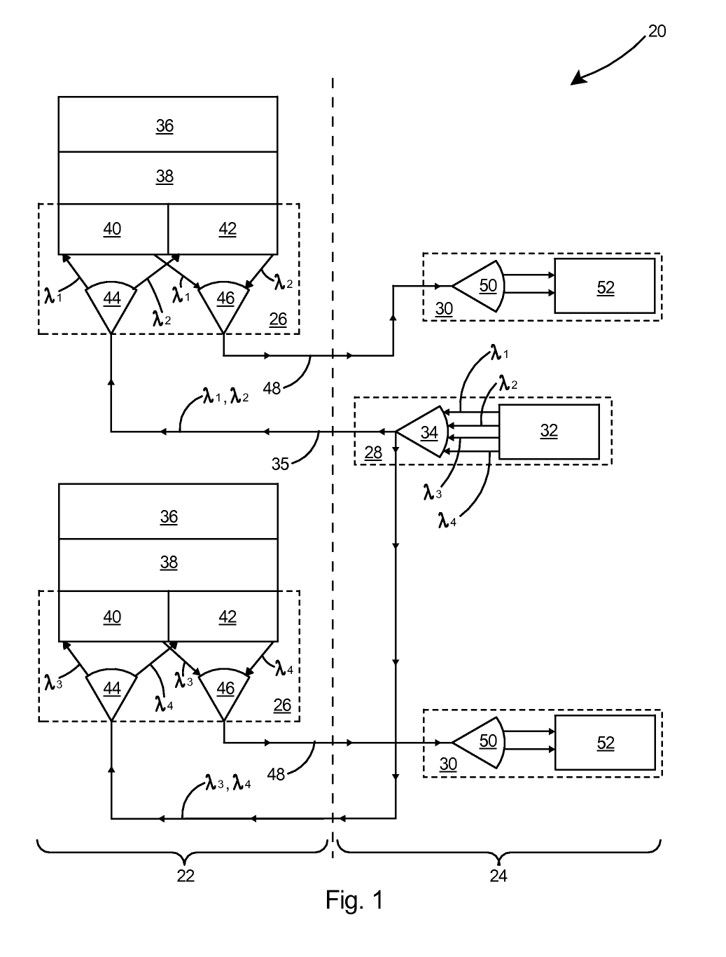

With reference to FIG. 1, there is shown a radiation detector 20 according to the present invention. The radiation detector 20 includes a front-end 22 and a back-end 24. The front-end 22 of the radiation detector includes an external-modulated electro-optical coupling detector (EOCD) 26 for nuclear physics instrumentation. The detector front-end 22 is capable of operating within an environment of high radiation and strong magnetic fields. The detector back-end 24 includes a laser light source module 28 and an optical receiver module 30 that may be placed in a location remote from the front-end 22 in order to enable it to operate within background radiation and magnetic fields. The laser light source module 28 consists of a plurality of lasers or laser array 32, in which each laser of the array is operated with its own wavelength (λ₁, λ₂, etc.). Laser outputs are multiplexed and distributed through a light source arrayed waveguide grating (AWG) 34 through an incoming single-mode fiber 35 to serve different detector front-ends. Each detector front-end 22 consists of a light sensor 36, electronics 38, modulators 40 and 42, and two AWGs, including an incoming AWG 44 and an outgoing AWG 46. Detected radiation pulses are first amplified to match the modulator driving voltage requirement. Selected wavelengths are fed through the detector front-end 22 incoming AWG 44 to feed into each modulator 40 and 42, and the radiation pulses converted optically inside the modulator. An outgoing AWG 46 then receives the selected wavelengths from modulators 40 and 42 and multiplexes a plurality of modulated wavelengths into an outgoing single-mode fiber 48. The optical receiver module 30 in the back-end 24 of the radiation detector includes a receiver AWG 50 and an optical receiver 52 for demultiplexing and converting optical pulses back into electrical pulses for digitization. The electronics corresponding to each light sensor are preferably an ASIC driver.

The EOCD based radiation detector 20 shown in FIG. 1 uses an external laser array light source 32 constructed by multiplexing many different wavelengths. The detector back-end 24, including light source module 28, is placed in an environment with low background radiation and magnetic fields, which can be located up to 5 KM from the detector front-end 22. Radiofrequency (RF) pulses produced by the light sensor 36 will be input to an electro-optical conversion device—a modulator—energized by laser light of a single wavelength. The intensity-modulated optical signal will be generated through the electro-optical conversion effects inside the EOCD 26 and will output encoded light pulses. A plurality of signal-carrying light wavelengths are then multiplexed into a single outgoing single-mode fiber 48 for transmission to the optical receiver at a remote location where the optical signals are translated back to electrical signals and signal processing can occur far from the signal source.

The method of electro-optical coupling using fiber optics according to the present invention involves the following basic steps:

(1) modulating electrical pulses and creating an optical signal using a modulator,

(2) relaying the signal along the fiber, minimizing distortion and loss, and

(3) receiving the optical signal, and converting it back into an electrical signal.

The radiation detector of the present invention preferably includes silicon-based photosensors. The silicon-based photosensors provide photon spectroscopy with high-energy resolution, vertex detection with high spatial resolution, and energy measurement of charged particles as low as a few MeV. The silicon-based photosensors are capable of withstanding strong magnetic fields as less susceptible to radiation damages than conventional photosensors.

Use of external modulated laser light to achieve electro-optical coupling, as shown in FIG. 1, is a critical feature of the EOCD system of the present invention. The EOCD front-end can be either analogue or digital depending on the degree of system integration. In general, the detector front-end consists of three sub-modules including a light sensor module, an ASIC module, and an electro-optical conversion and multiplexing module. The laser array, located outside the high radiation and strong magnetic field areas, provides the EOCD front-end with a plurality of laser wavelengths through a single-mode fiber. Each electro-optical conversion device in the electro-optical conversion and multiplexing module receives only one wavelength, through the incoming AWG, demultiplexed from the incoming laser and provides RF optical modulation for either digital or analogue pulses. Optical signals produced through an array of such devices carried over many wavelengths are then multiplexed by an outgoing AWG to form an output through a single-mode fiber.

Nuclear physics and particle physics experiments require a strict amplitude, phase, and timing relationship among detected pulses from a single event. It demands the detector's homogeneous systematic response to these analogue quantities before digitization. The conventional instrumentation design, with ribbon or coaxial cables, however, is susceptible to electro-magnetic interferences as well as differences introduced by inhomogeneities in the transmission line, e.g., connector capacitance or shielding. The EOCD of the present invention utilizes WDM technology through the use of AWGs to maintain the relative amplitude, phase, and timing relationship among detector channels or between different detectors.

WDM is an efficient method where several optical pathways (channels), each carried by a different optical wavelength, are transmitted through a single-mode optical fiber, utilizing more of the available frequency bandwidth without increasing the effects of dispersion. Each channel, as a result of being effectively separated from the others by frequency band gaps, can be operated independently in protocol, speed, and direction of information transportation. AWGs are optical wavelength multiplexers/demultiplexers used to fulfill WDM transmission. In the EOCD, AWG is mainly used to multiplex several modulated wavelengths onto a single-mode optical fiber at the detector front-end and are also used as a demultiplexer to retrieve individual channels of different wavelengths at the receiver end. WDM utilization enables an all-optical nuclear detector architecture where signals are routed according to wavelength.

In the EOCD radiation detector of the present invention, electrical charges are produced in a radiation photon sensor when a nuclear event happens, and these charges are immediately amplified and launched into optical domain by optical modulation—an operation that converts the electrical signal into an optical signal. Two methods can be used to perform this operation. The first method is direct modulation, wherein light is emitted from a semiconductor laser in proportion to the charges received. Current art EOCDs are all based on this modulation scheme. The second method, utilized in the radiation detector of the present invention, is external modulation. In external modulation, a continuous wave (CW) laser is used to emit light whose power is constant with time. The emitted light is fed into an optical modulator to control the amount of light passing through according to the electrical charge intensity. The external modulation enables achievement of a radiation resistant and magnetic field immune radiation detector while maintaining overall linearity and electro-optical conversion efficiency.

In order to preserve the fidelity of the analogue optical signal, the EOCD uses a single-mode fiber rather than multi-mode fiber operated near 1550 nm. Optical signals distributed over many wavelengths, transmitted through a fiber and photo-detected in receivers require minimized signal distortions. The EOCD design takes into considerations several factors, including fiber transmission impairments caused by fiber nonlinearities, inter-modal dispersions, and chromatic dispersion. Because EOCD requires relative short distance fiber transmission, typically less than 2 km, fiber transmission distortions such as chromatic dispersion, polarization-mode dispersion, and fiber attenuations can be largely neglected. The short distance fiber transmission scheme simplifies transmission considerations to only fiber nonlinearities and inter-modal dispersions.

The power dependence of refractive index (fiber nonlinearity) is called Kerr-nonlinearity. Depending upon the type of input signals, the Kerr-nonlinearity manifests itself in three different effects such as Self-Phase Modulation (SPM), Cross-Phase Modulation (CPM) and Four-Wave Mixing (FWM). Except for SPM and CPM, all nonlinear effects provide gains to some wavelengths at the expense of depleting power from other wavelengths. SPM and CPM affects only the phase of signals and can cause spectral broadening leading to increased dispersion. In the EOCD arrangement of the current invention, controlling the amount of optical power injection into the fiber for each wavelength enables avoidance of the Kerr-nonlinearity.

The analogue optical pulse transmission in EOCD requires minimum fiber transmission dispersions for high-fidelity signal preservation. Multi-mode fiber transmission introduces large optical pulse spreading because of inter-modal dispersion—distorting optical pulse amplitude, phase and arrival time even for a short transmission distance, e.g., 100 meters. The current multi-mode fiber electro-optical coupling is useful in a digital transmission scheme where pulse digitization is needed in the detector front-end before transmission and dispersion compensation schemes are implemented after the optical receiver.

For the multi-wavelength laser array, the radiation detector utilizes external laser modulation in the EOCD arrangement. Preferably, the laser array operates at approximately 1550 nm. External laser modulation enables integration of the detector front-end photon-sensor and electro-optical conversion component into a small footprint (compact size), and separates the laser array (light source) from the high radiation and strong magnetic field environment. Use of external modulation to physically separate the detector front-end and laser array guarantees a high quality laser light source with minimum wavelength drifting in all wavelengths for high-fidelity light pulse readout. External modulation enables the sharing of a single laser array between several detectors, thereby enabling detector clustering and homogeneous readout in a detector cluster.

For the laser array light source and receivers, which are placed in the background fields, there are no special requirements. However, the front-end of the EOCD must be radiation tolerant and immune to magnetic fields, and it requires device materials, structures, and functions that can survive in these harsh environments. To meet the radiation hardened and magnetic field immune requirement, the photon sensors 36 are preferably silicon photomultipliers (SiPM) and the AWGs are preferably silica (glass) based.

### EOCD Example:

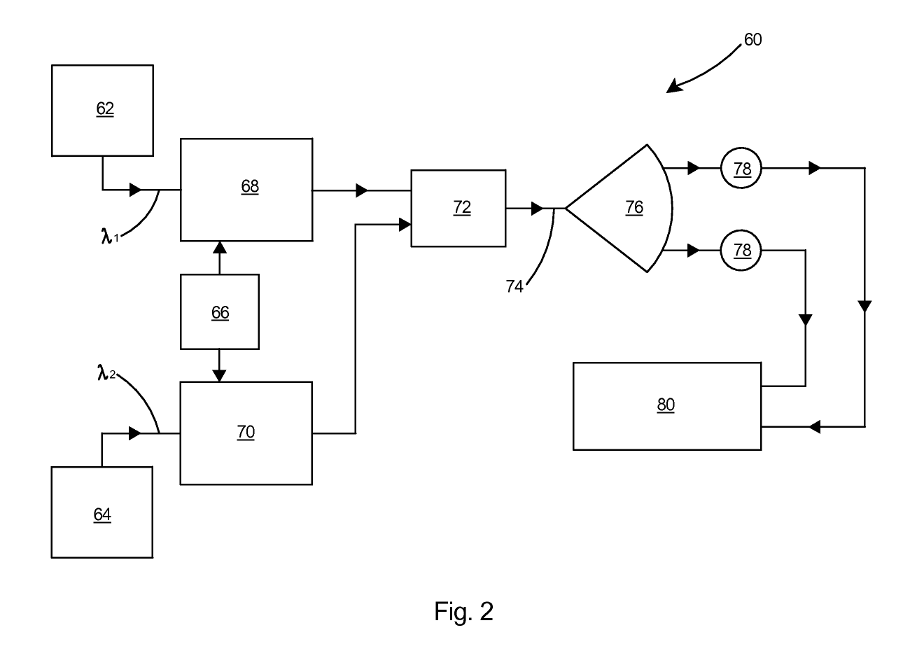

With reference to FIG. 2, a two-wavelength EOCD system 60 was constructed, using functional operations using commercially available components, to test the feasibility of an EOCD according to the present invention. A light source, including a first laser 62 and a second laser 64, was constructed using International Communication Union (ITU) standard grid lasers. A waveform generator 66 was used to generate optical signals. Lithium niobate (LiNBO₃) optical modulators 68 and 70 were installed to modulate electrical signals into the optical domain via each laser's operating wavelength (λ1 and λ₂) and then multiplexed by a waveguide combiner 72 into a single-mode fiber 74 for optical transmission. In the optical receiver end, two wavelengths are demultiplexed through a 1:16 ITU grid AWG 76 and then electrically converted by optical-photon detectors 78 before digitization. The electrical pulses detected after the electro-optical coupling preserved the original signal characteristics, demonstrating the feasibility of the EOCD method of the present invention. The EOCD 60 as described herein enables a compact, low mass, radiation tolerant and magnetic field immune detector for nuclear physics instrumentation. It is capable of greatly reducing the size and complexity of instruments associated with applications of nuclear physics techniques.

In order to reduce system complexity for the two-wavelength EOCD 60 and lessen optical loss induced by components interconnections, instead of using AWG to multiplex the laser light wavelengths before transmission to the LiNBO₃ modulators 68 and 70, the modulated laser pulses are multiplexed by a waveguide combiner 72, which is a much simpler device analogous to AWG multiplexing function for two wavelengths. A 1:16 AWG 76 was used to demultiplex and select a wavelength for each optical receiver 78. All the discrete component optical connectors in the two-wavelength EOCD are either SC/APC (before the waveguide combiner 72) or LC connectors (after the waveguide combiner 72) to minimize optical loss due to conversion for optical connectors. The waveguide combiner 72 combined the two close wavelengths, approximately 1553 nm and 1554 nm, into a single-mode fiber.

The light source consisted of two 1550 nm near-infrared continuous wave (CW) lasers and the two wavelengths were tuned by controlling their independent temperature controllers (not shown). Both lasers have a maximum optical power dissipation of 20 mW and the actual optical power dissipation was controlled by their laser diode drivers (not shown) through laser injected electrical current.

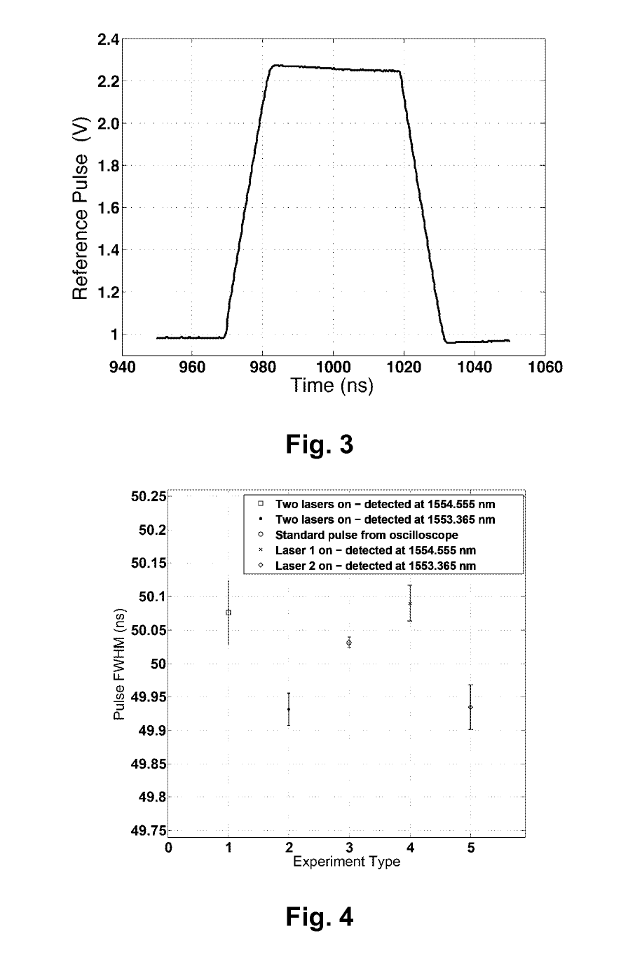

The waveform generator 66 generated a square wave with width 50 ns, and both its leading edge and trailing edges are 10 ns, as shown in FIG. 3. The square wave pulse included a repetition frequency of 1 MHz and pulse amplitude near 1.25 volts to drive the LiNBO3 modulators 68 and 70.

The 1:16 ratio AWG 76 was demonstrated the AWGs capability to separate two close wavelengths with 40 dB side-band suppression, demonstrating that the crosstalk between separated wavelengths is negligible. A planar arrayed waveguide was used to separate two multiplexed wavelengths from a single-mode fiber transmission. The AWG included 100 GHz channel spacing with ITU grid standard WDM wavelength allocations (center wavelength in nm: 1548.515, 1549.315, 1550.116, 1550.918, 1551.721, 1552.524, 1553.329, 1554.134, 1554.940, 1555.747, 1556.555, 1557.363, 1558.173, 1558.983, 1559.794, 1560.606). Each AWG demultiplexed output channel included a unique channel number corresponding to its center wavelength. The radiation detector of the present invention could be constructed with an AWG having a ratio of 1:16, 1:32, 1:64, 1:128, or 1:160.

The two AWG-separated wavelengths are then fed to optical receivers 78 for optical electrical conversion. For comparison and data acquisitions, the converted electrical pulses were subsequently fed into an oscilloscope 80 together with the original square pulse output from the arbitrary waveform generator.

Using the two-wavelength EOCD of FIG. 2, a near square pulse is provided from the arbitrary waveform generator 66. The first laser 62 was tuned to 1554.555 nm such that AWG channel 8 has maximum optical power. Similarly, the center wavelength of the second laser 64 was tuned up by its temperature control to 1553.365 nm such that AWG channel 7 has maximum optical power output. The two-wavelength EOCD 60 was operated at a room temperature of 22.3° C.

Two separate experiments were conducted. The first experiment tested the high-fidelity electro-optical signal coupling with two wavelengths (wavelength 1554.555 nm—L1 signal—and 1553.365 nm—L2 signal). Afterwards, the second experiment demonstrated negligible inter-wavelength/channel crosstalk in the single fiber 74 of the EOCD 60.

Each experiment included individual wavelength transmission as well as simultaneous two-wavelength transmission. The results are presented in both time domain pulse analysis using capture pulses in the oscilloscope (Tektronix DPO 4104 Digital Phosphor Oscilloscope available from Tektronix, Inc. of Beaverton, Oreg.) as well as optical spectrum analysis (UBICS Model 701, available from GN Nettest, France) in the wavelength domain.

### Experimental Results of EOCD Example

As shown in FIG. 3, two identical pulses are launched into their respective modulators externally pumped by its laser wavelength. The optically modulated pulses are then multiplexed into a 2 meter single-mode fiber, and after AWG demultiplexing and optical receiver photo-detection, the pulses are fed into the oscilloscope for comparison. There are four types of parameters to characterize a pulse, i.e., pulse full width half-maximum (FWHM), rising edge time, falling edge time, and amplitude. Comparison among these quantities and its statistics will indicate how EOCD maintained the pulse features, and thereby verifying the high fidelity transmission capabilities of the EOCD system.

FIGS. 4-7 show the comparisons between these pulse quantities in five types of experiments. (1) Type 1: Both laser 1 and 2 are on, same pulse modulated through two laser wavelengths and then combined into a single fiber through the wavelength combiner, AWG channel 8 (1554.555 nm) and the receiver subsequently converting the light pulse into an electrical pulse that is recorded by the oscilloscope. Ten individual results are captured. (2) Type 2: Both laser 1 and 2 are on, same pulse modulated through two laser wavelengths and then combined into a single fiber through the wavelength combiner, AWG channel 7 (1553.365 nm) and the final reconverted signal pulse recorded by the oscilloscope. Ten individual results are captured. (3) Type 3: Pulse from waveform generator directly fed into oscilloscope and ten individual results are captured. (4) Type 4: Laser 1 is on and laser 2 is off. The pulse is modulated by laser 1, going through the same route and AWG channel 8 (1554.555 nm) and the final pulse captured in oscilloscope. Ten individual results are captured. (5) Type 5: Laser 1 is off and laser 2 is on. The pulse is modulated by laser 2, going through the same route and AWG channel 7 (1553.365 nm) and the output pulse recorded by the oscilloscope. Ten individual results are captured.

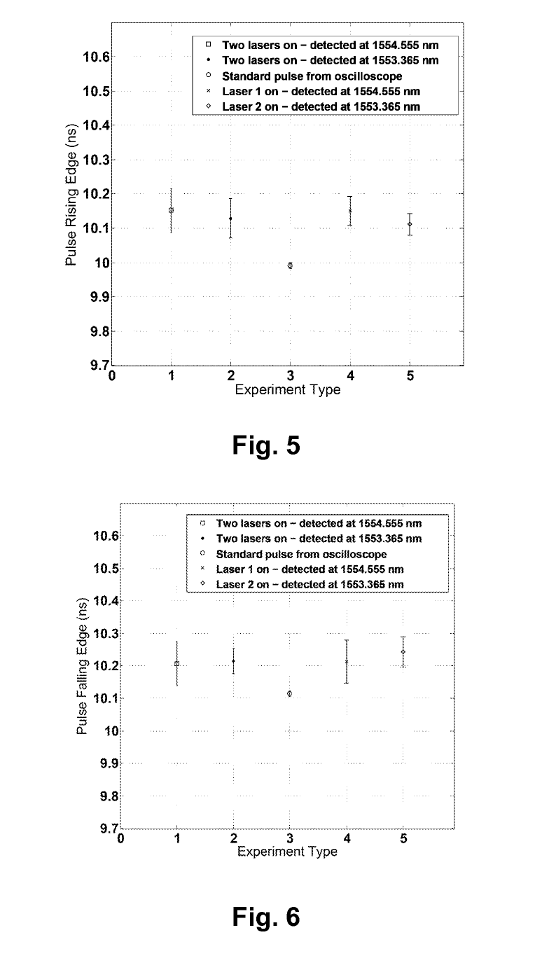

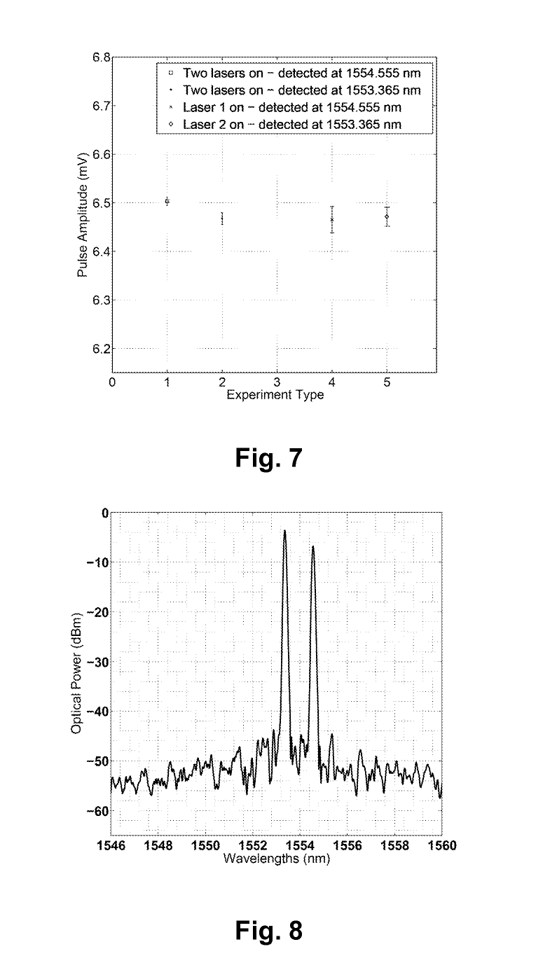

FIG. 4 compares the optical pulse FWHM among 5 experimental types and displayed error bars with 1% scale zoom in, i.e., vertical scale is 1% of the actual FWHM. Similarly, the rising edge and falling edge were compared respectively in FIGS. 5 and 6 with 10% zoom in, i.e., vertical scale is 10% of the actual rising or falling edge values, and the results displayed with error bars for statistical significance. At last, in FIG. 7, the pulse amplitude was compared among four experiment types except type 3, with 10% pulse amplitude zoom in, i.e., vertical scale is 10% of the average received amplitude values.

For all five experiment types, the FWHM distortion shown in FIG. 4 is around 0.2%, and their rising and falling edge time distortion are less than 2% in both FIGS. 5 and 6. The experiments also show that the amplitude difference between the two wavelengths is equalized to less than 1% fluctuation in FIG. 7 except for type 3. The type 3 experiment directly measures the signal amplitude from the arbitrary waveform generator while the other experiments suffer severe signal loss along their optical coupling paths through the optical modulator (˜6 dB), optical fiber connectors (2-3 dB per connector for a total of 4 connectors), waveguide combiner loss (3 dB), and AWG device insertion loss (˜2 dB). The actual amplitude loss can be compensated by amplifiers after the receivers. In all experiments conducted in this research, no amplifiers were implemented, making the type 3 experiment signal amplitude approximately 23 dB, stronger than the other four cases.

Referring to FIG. 8, one output of the waveform combiner, i.e., 50% of combined optical power from two pulse-modulated laser wavelengths in a fiber, was scanned using an optical spectrum analyzer. Two optical peaks were identified with their center wavelengths at 1553.365 nm and 1554.555 nm, a 1.19 nm distance between two wavelengths. It was noticed that the 1553.365 nm wavelength has its peak optical power −3.5707 dBm (power ratio in decibels of the measured power referenced to one milliwatt) while the 1554.555 nm has −6.7876 dBm. The difference between these two wavelengths was intentionally used to compensate the optical attenuation differences such that the received electrical pulses, after the EOCD, will be equalized for uniform radiation detector response.

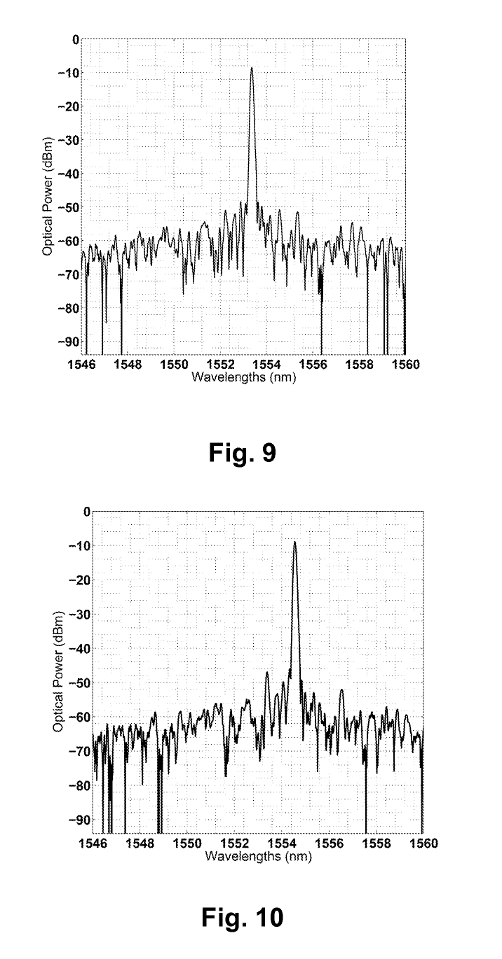

Referring to FIG. 2, after the waveform combiner 72, two pulse-modulated wavelengths are carried through a single-mode fiber 74 through a distance, which distance should be long enough to route to a background radiation and magnetic field environment, and then demultiplexed by the AWG 76. When the two wavelengths are passed through the AWG 78, they were spatially separated, such that each wavelength could be filtered out by the optical receiver 78. FIGS. 9 and 10 show that both 1553.365 nm and 1554.555 nm were successfully separated through the 1:16 ratio AWG and their optical power detected after the AWG are −8.5423 dBm and −8.9750 dBm, respectively.

To understand the inter-wavelength crosstalk impact towards the EOCD system, one of the two lasers was turned off, allowing only one of the wavelengths to pass through. The peak power difference between the simultaneous two laser-on transmission and the one laser-on transmission were compared, and their difference are less than 0.52% for both 1553.365 nm and 1554.555 nm. This result demonstrated the inter-wavelength crosstalk is negligible.

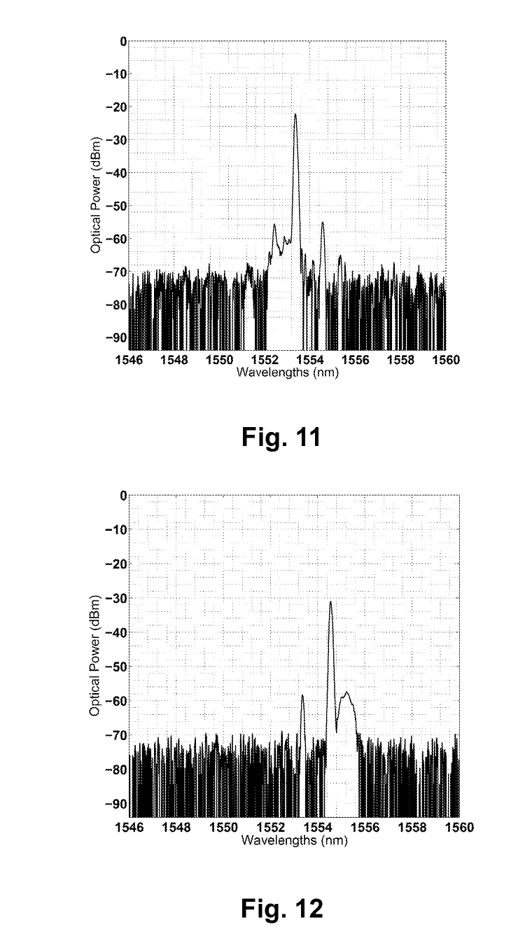

The optical power in the AWG channel 7 and 8, i.e., actual output wavelengths 1553.365 nm and 1554.555 nm, may contribute its output power to its neighboring channels, such as channel 6 and channel 9. In order to understand the degree of inter-channel interferences, optical spectrum scanning was conducted for both channel 6 in FIG. 11 and channel 9 in FIG. 12. As one can see, in FIG. 11, at 1553.365 nm, the optical power reached its peak at −22.96 dBm, a 14.42 dB attenuation from the channel 7. Channel 6 could also see a very weak 1554.555 nm peak with its optical power at almost −55 dBm. Similarly, in FIG. 12, one could see both 1553.365 nm and 1554.555 nm, the optical power reached its peak at −31.56 dBm at 1554.555 nm while only −58 dBm for the 1553.365 nm wavelength. We further scanned channels 5 and 10, and detected negligible effective optical power peaks below −53 dBm. From the results presented in FIGS. 8-12, we could conclude that the inter-wavelength crosstalk in an EOCD system is truly negligible.

### Summary of Experimental Results of EOCD Example

An optical modulator for use in a compact radiation tolerant and magnetic field immune radiation an electro-optical coupling detector according to the present invention is preferably constructed of LiNBO₃, InP, polymers, or silicon. More preferably, the optical modulator is constructed of InP or polymer. Most preferably, as a result of its superior resistance to radiation, the optical modulator is constructed of InP. InP light transportation phase shift can be controlled in a Mach-Zehnder Interferometer and this phase shift is neither sensitive to the magnetic fields nor susceptible to the temperature variations. These desirable characteristics of InP enable an electrical signal to be coupled into optical pulses through its switching voltage V_{π} curve in a modulator.

An EOCD system according to the present invention will provide high-fidelity radiation signals in a high radiation and strong magnetic field environment. It is critically important to minimize the modulator size in such an EOCD system as the EOCD front-end requires integrating a plurality of such modulators in an area equivalent to its photon sensor. An EOCD frontend modulator according to the present invention must also meet requirements for low input-voltage with efficient linear electrical-optical coupling conversion (less insertion loss), stable temperature response, and low-cost to manufacture. The reduction of insertion loss in the modulator is particularly important in the EOCD implementation.

All these important modulator design requirements place limits on a desirable electrical-optical conversion material, so that characteristics demonstrated in the two-wavelength EOCD experiments will be inherited while the entire EOCD front-end could be further integrated and manufactured into a compact device resistant to both high radiation and strong magnetic fields. Modulators made of InP material have the potential to fulfill all these stringent requirement with good performance.

In the two-wavelength crosstalk studies, in order to adjust one of two lasers wavelength to 1553.365 nm, we have pushed its thermo-electrical cooler (TEC) to 119° C., which is far from its normal operating temperature. This broadened the laser's wavelength line-width, which introduced a small amount of channel crosstalk. From FIG. 11, the AWG output channel 6 could also see 14.41 dB attenuated in the 1553.365 nm wavelength peak, that is, the optical power flow from channel 7 to channel 6. If laser line width were optimized within the lasers TEC control specification, one would expect much smaller (>22 dB attenuation) channel crosstalk, as it is demonstrated in channel 9 for the wavelength 1554.555 nm in FIG. 12.

Nuclear physics experimentation often requires high timing resolution for short pulses with fast rising edge and/or falling edge, e.g., pulses with 10 ns FWHM and 2-3 ns rise time. The EOCD of the present invention could accommodate these requirements because each wavelength could include a bandwidth of 100 GHz, which is equivalent to 3.5 ps rise/fall time for the pulse. In this case, the system is not restricted by the factors of optical transmission. High-fidelity radiation pulse detection and transmission can be restricted by many factors in the current two-wavelength EOCD system. In the current system, the electronic components (such as the optical receivers and RF transmission wire) restricted the realized transmission bandwidth. If there is insufficient bandwidth for any of the components, pulse distortion could happen. Differing test pulses were tried with a constant FWHM of 50 ns but with different rising or falling edges of 10 ns, 7.5 ns, and 5 ns. It was shown that as pulse rising or falling edges time reduced, the bandwidth impacted the fidelity of the received pulses. In this case, an optimized EOCD bandwidth is the key to achieve EOCDs high-fidelity feature.

The EOCD system long-term stability was also studied. The two-wavelength experiment was setup in a laboratory with stable temperature around 22.3° C. The system had been repeatedly cycled on and off, but there was no significant pulse-level or wavelength drifting observed in a consecutive one-week experiment. Because an external laser modulation scheme was implemented in the EOCD system (separating the laser wavelength generation and the electro-optical conversion/modulation), the multi-wavelength lasers could be controlled reliably by their current and TEC controllers, resulting in long-term system stability. A heated AWG is preferable to an ambient-temperature AWG, because AWGs wavelength response could be precisely specified. However, in the work for this paper, by putting the AWG into a stable room temperature environment, one could control the amount of wavelength shift and stabilize AWG performance.

Although the description above contains many specific descriptions, materials, and dimensions, these should not be construed as limiting the scope of the invention but as merely providing illustrations of some of the presently preferred embodiments of this invention. Thus the scope of the invention should be determined by the appended claims and their legal equivalents, rather than by the examples given.

What is claimed is:

1. A method of detecting radiation, comprising:
a) providing a front-end including a plurality of light sensors and an electro-optical conversion and multiplexing detector (EOCD) associated with each of said light sensors;
b) providing a back-end including an optical receiver module having a demultiplexer and an optical receiver corresponding to each of said light sensors, and a light source module including a multi-wavelength light source;
c) providing an incoming single-mode fiber and an outgoing single-mode fiber extending between said front-end and said back-end;
d) multiplexing the multi-wavelength light from said multi-wavelength light source and transmitting the resulting optical signals over said incoming fiber to said EOCD;
e) simultaneously modulating and multiplexing pulses from said light sensors by converting them into optical signals in said EOCD;
f) transmitting said optical signals through said outgoing single-mode fiber to said optical receiver;
g) demuliplexing said optical signals in said demultiplexer;
h) receiving said optical signals in said optical receiver module; and
i) converting said optical signals into electrical signals.

2. The method of claim 1 including
providing an incoming arrayed waveguide grating (AWG), an outgoing AWG, and a modulator in said EOCD;
selecting a wavelength in said incoming AWG to create a modulated output signal; and
feeding said modulated output signal to said outgoing AWG.

3. The method of claim 2 including
multiplexing a plurality of modulated wavelengths in said outgoing AWG; and
transmitting optical signals from said outgoing AWG onto said outgoing single-mode fiber.

4. The method of claim 1 wherein said front-end is radiation tolerant and magnetic field immune.

5. The method of claim 1 wherein said light sensors are selected from the group including semiconductor photodetectors and silicon-based photosensors.

6. The method of claim 1 wherein said incoming AWG and said outgoing AWG are selected from the group including silica glass and indium phosphide (InP).

7. The method of claim 1 including electronics associated with each of said light sensors.

8. The method of claim 1 including separating said front-end and said back-end by a distance of up to 5 kilometers.

9. The method of claim 7 wherein said optical modulators are selected from the group including lithium niobate (LiNBO₃), indium phosphide (InP), polymers, and silicon.

10. The method of claim 6 wherein said incoming AWG and said outgoing AWG include a ratio selected from the group including 1:16, 1:32, 1:64, 1:128, and 1:160.

11. The method of claim 2 wherein said receiver AWG demultiplexes wavelengths and selects a wavelength for said optical receiver.

12. The method of claim 2 wherein converting said optical signals into electrical signals includes
providing a receiver AWG in said optical receiver;
demultiplexing said optical signals from said EOCD in said receiver AWG; and
converting the output of said receiver AWG into electrical pulses in said optical receiver.

13. The method of claim 2 wherein multiplexing the multi-wavelength light from said multi-wavelength light source and transmitting the resulting optical signals over said incoming fiber to said EOCD includes a laser array and a light source AWG in said light source module.

14. The method of claim 12 wherein said outgoing single-mode fiber extends between said outgoing AWG of said EOCD and said receiver AWG of said optical receiver module.

15. The method of claim 13 wherein said incoming single-mode fiber extends between said light source AWG of said light source module and said incoming AWG of said EOCD.

16. A method of electro-optical coupling using fiber optics, comprising:
a) modulating electrical pulses;
b) converting said electrical pulses into optical signals using a modulator;
c) relaying said optical signals along a single-mode fiber thereby minimizing distortion and loss; and
d) receiving said optical signals; and
e) converting said optical signals into an electrical signal.

17. A radiation detector, comprising:
a front-end including a plurality of light sensors, electronics associated with each of said light sensors, and an electro-optical conversion and multiplexing detector (EOCD) associated with each of said light sensors;
a back-end including an optical receiver and a multi-wavelength light source;
an incoming single-mode fiber and an outgoing single-mode fiber extending between said front-end and said back-end;
said EOCD including an incoming arrayed waveguide grating (AWG), a modulator, and an outgoing AWG.

18. The radiation detector of claim 17 wherein said multi-wavelength light source is a laser array.

19. The radiation detector of claim 17 wherein
said optical receiver includes a receiver AWG; and
said outgoing single-mode fiber extends between said outgoing AWG of said EOCD and said receiver AWG of said optical receiver module.
